(19) United States
(12) Patent Application Publication
(10) Pub. No.: US 2015/0046788 A1
(43) Pub. Date: Feb. 12, 2015

(54) DYNAMIC BROWSER HOMEPAGE CHANGING

(71) Applicant: Lenovo (Singapore) Pte. Ltd., Singapore (SG)

(72) Inventors: Jeffrey Mark Estroff, Cary, NC (US); Russell Stuart Gantman, Fuquay Varina, NC (US); Russell Speight VanBlon, Raleigh, NC (US)

(73) Assignee: Lenovo (Singapore) Pte. Ltd., Singapore (SG)

(21) Appl. No.: 13/961,430

(22) Filed: Aug. 7, 2013

(51) Int. Cl. G06F 17/24

(52) U.S. Cl. CPC G06F 17/24
USPC 715/234

(57) ABSTRACT

An aspect provides a method, including: accessing a memory storing information comprising web page information and timing information; identifying, using the one or more processors, a new web page to use as a homepage based on the web page information and the timing information; and changing, using the one or more processors, a home page setting in a web browser to the new web page according to the web page information and the timing information. Other aspects are described and claimed.

### BACKGROUND

Information handling devices (“devices”), for example cell phones, smart phones, tablet devices, laptop and desktop computers, e-readers, etc., employ one or more web browser application(s) to load and view web pages. There are a variety of different web browsers currently available. Many devices are capable of running more than one web browser at a time, whereas some devices utilize a dedicated web browser.

In web browsers, an initial page is loaded when the web browser is first opened or launched. This initial page is referred to as a homepage and may be set. In a web browser application, the homepage will be set to a default such that a URL is listed as the homepage. This URL may be changed by a user such that the initial or homepage may be updated to suit the user's need or desire. To change the default homepage (or current homepage, if already changed), a user opens the web browser application and enters modified settings, e.g., types in a new URL for the homepage and saves the updated settings.

In some web browsers, multiple “homepages” may be set, e.g., such that a web browser that supports “tabbed” browsing loads multiple homepages (a set of homepages) simultaneously. Thus, the user may be presented with more than one web page (opened in different tabs) on launching of the web browser. Other web browsers open a default view (e.g., without opening a specific web page) that provides (e.g., in panels or icons (e.g., screen captures presented as thumbnails)) recently viewed web pages or popular web pages, which the user may click on to navigate to the clicked web page.

### BRIEF SUMMARY

In summary, one aspect provides a method, comprising: accessing a memory storing information comprising web page information and timing information; identifying, using the one or more processors, a new web page to use as a homepage based on the web page information and the timing information; and changing, using the one or more processors, a home page setting in a web browser to the new web page according to the web page information and the timing information.

Another aspect provides an information handling device, comprising: a display device; one or more processors; a memory device accessible to the one or more processors and storing code executable by the one or more processors to: access a memory storing information comprising web page information and timing information; identify a new web page to use as a homepage based on the web page information and the timing information; and change a home page setting in a web browser that displays a home page on the display device to the new web page according to the web page information and the timing information.

A further aspect provides a program product, comprising: a storage device having computer readable program code stored therewith, the computer readable program code comprising: computer readable program code configured to access a memory storing information comprising web page information and timing information; computer readable program code configured to identify a new web page to use as a homepage based on the web page information and the timing information; and computer readable program code configured to change a home page setting in a web browser to the new web page according to the web page information and the timing information.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of dynamic browser homepage changing.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Although web browsers allow users to manually provide inputs to change a homepage (e.g., typing in a new URL into a settings menu), there is currently no mechanism in place to adjust the default web browser homepage dynamically, e.g., based on user browsing history, time of the day, day of the week, a combination of the foregoing, etc.

Accordingly, an embodiment provides a web browser feature that learns the web browser patterns of use, e.g., based on web pages loaded or accessed during a particular the time of the day or day of the week, and automatically adjusts the web browser homepage according to the website(s) the user most often visits at that time of day or day of week in question (i.e., when the web browser is opened or launched).

For example, a user may browse a particular news organization's web site on weekday mornings to catch up on the world news—so the web browser homepage would be set to this particular news organization's web site by an embodiment during an appropriate portion of the day, e.g., between 7:00 a.m. and 9:00 a.m. on weekdays. As another example, a user may wish to view the local traffic report in the afternoon before setting out on the drive home—so the web browser homepage would be set to a local news organization's traffic update web page by an embodiment between 5:00 p.m. and 6:00 p.m. on weekdays. Similarly, an embodiment may extend this principle given the capabilities of the web browser in question. For example, if the user configures their web browser for multiple tabbed homepages, each tab could be configured with a separate scheduled home page.

An embodiment may be sensitive to user choice regarding the dynamic updating of the homepage. For example, if a user opens the web browser and, upon seeing the homepage dynamically selected, provides an indication of dissatisfaction of the new homepage (e.g., changes web pages before the homepage loads or within a predetermined time), an embodiment may take this into account and perform an additional action. For example, an embodiment may change, responsive to an indication of dissatisfaction, the home page automatically to another web page (e.g., the one navigated to by the user) or disable the dynamic updating feature for a predetermined time.

The illustrated example embodiments will be best understood by reference to the figures. The following description is intended only by way of example, and simply illustrates certain example embodiments.

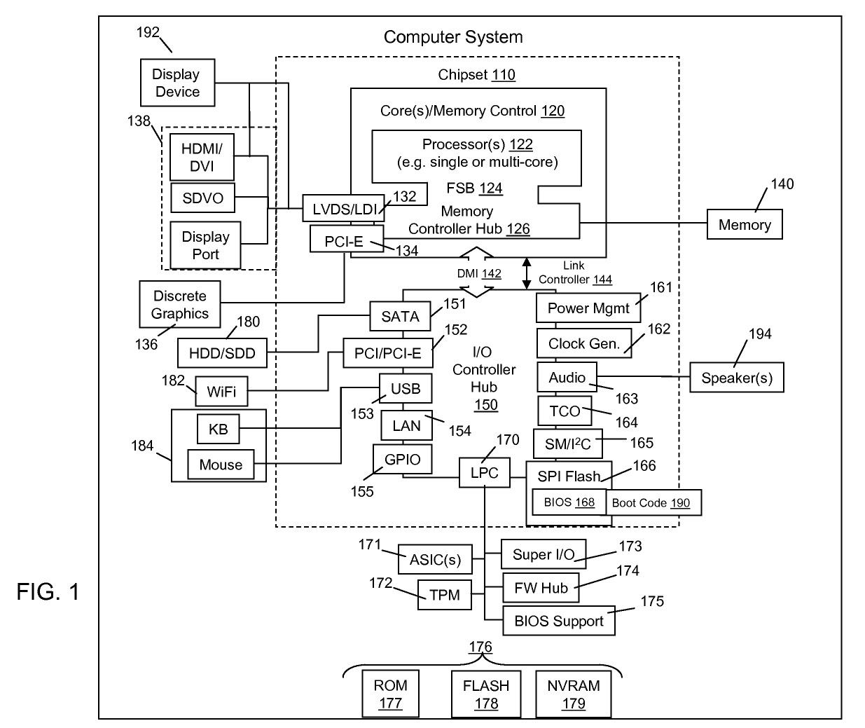

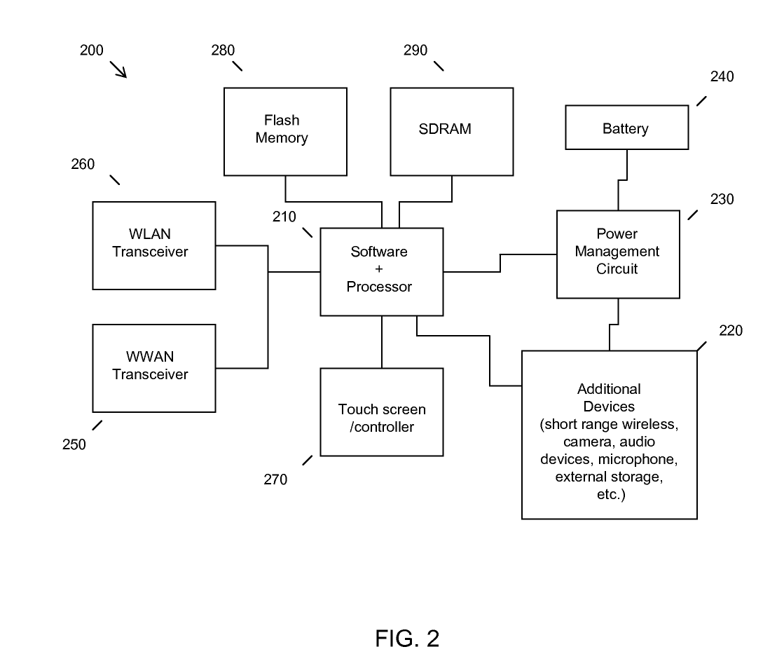

Referring to FIG. 1 and FIG. 2, while various other circuits, circuitry or components may be utilized in information handling devices, with regard to smart phone and/or tablet circuitry 200, an example illustrated in FIG. 2 includes a system on a chip design found for example in tablet or other mobile computing platforms. Software and processor(s) are combined in a single chip 210. Internal busses and the like depend on different vendors, but essentially all the peripheral devices (220) may attach to a single chip 210. In contrast to the circuitry illustrated in FIG. 1, the circuitry 200 combines the processor, memory control, and I/O controller hub all into a single chip 210. Also, systems 200 of this type do not typically use SATA or PCI or LPC. Common interfaces for example include SDIO and I2C.

There are power management chip(s) 230, e.g., a battery management unit, BMU, which manage power as supplied for example via a rechargeable battery 240, which may be recharged by a connection to a power source (not shown). In at least one design, a single chip, such as 210, is used to supply BIOS like functionality and DRAM memory.

System 200 typically includes one or more of a WWAN transceiver 250 and a WLAN transceiver 260 for connecting to various networks, such as telecommunications networks and wireless base stations. Commonly, system 200 will include a touch screen 270 for data input and display. System 200 also typically includes various memory devices, for example flash memory 280 and SDRAM 290.

FIG. 1, for its part, depicts a block diagram of another example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1 and FIG. 2, may operate web browser applications (“web browsers”). The web browser is loaded, initiated or launched responsive to user input, e.g., a user clicking on or touching an icon an a display screen to open the web browser. On opening the web browser, the information handling device executes code, e.g., as provided by the web browser application, to identify a URL used for a homepage. This URL is loaded into the web browser and the corresponding web page (web page and web site are used interchangeably herein) is retrieved, loaded and displayed by the web browser. As described herein, a web browser may load a set of web pages as a default homepage setting (e.g., in a tabbed viewing use case).

An embodiment extends this functionality by building in intelligence to the process of selecting and loading a homepage. Instead of simply loading a URL (or set of URLs) indicated in a homepage setting of a web browser, an embodiment dynamically updates the homepage setting such that more appropriate web pages may be retrieved, loaded and displayed as the homepage.

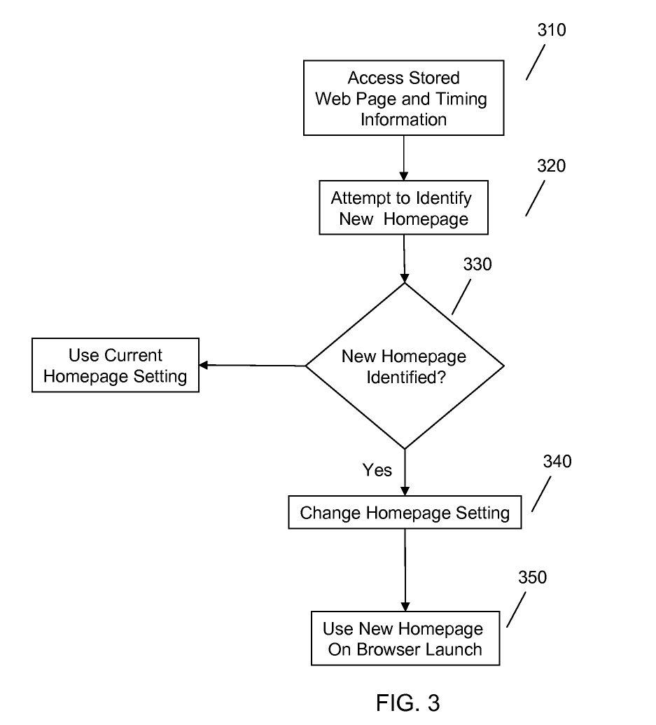

Turning to FIG. 3, an example method of dynamically changing a homepage is illustrated. In an embodiment, an application accesses stored web page and timing information at 310. The application may be included in a web browser itself, as part of an operating system, a combination of the foregoing, or as a stand alone application that is downloaded and functions in concert with the web browser (e.g., a downloadable web browser extension). The web page information comprises a stored history of web pages accessed by the device, e.g., as stored in a browsing history. The timing information includes timing information of the web page accesses, e.g., a local device time at which each of the web pages in the browsing history is/was accessed. Such information may be stored in a memory of the device and logically associated with one or more applications (e.g., the web browser).

At 320, an embodiment attempts to identify a web page as a new homepage, i.e., one that is different from a current homepage. The current homepage will be identifiable via the web browser settings (e.g., in the form of a stored URL addressing a web page and stored in the web browser settings). The identification of a new homepage may take a variety of forms (i.e., a variety of algorithms may be performed in an attempt to identify a new homepage).

As an example, the web page and timing information may indicate that a user accesses a particular web page frequently, although not exclusively, at the time period between 7:00 a.m. and 9:00 a.m. Thus, if this web page (frequently accessed at the particular time, e.g., device local time) is different than the currently listed homepage, a new home page has been identified in the context of that time period. If the currently listed homepage is the same as the new homepage, then the current homepage setting may be used/unchanged.

The identification may include creating a time based-ranking of web pages derived from a history of web page visits stored as web page information and timing information. Thus, an embodiment may change the homepage setting to the new web page based on the time-based ranking and the local time at the information handling device. Thus, a top ranked (per the user's browsing history) web page for a given time or period of time may be identified as the new home page.

If the new homepage is different from the currently listed homepage, i.e., a new homepage is identified, an embodiment may change the homepage setting to the new homepage. For example, an embodiment may remove the URL of the current homepage in the web browser settings and insert therein a new URL pointing to a web site as the new homepage.

The dynamic changing of the homepage may occur in a variety of ways. For example, an embodiment may frequently attempt to identify a new homepage and frequently change or update the homepage setting to accurately reflect the new homepage identified. For example, an embodiment may attempt to identify a new homepage in a periodic or predetermined way, e.g., every “X” hours, days, etc. Similarly, an embodiment may change the homepage setting following an identification of a new homepage frequently, e.g., changing the homepage setting to the new homepage within “X” units of time of identifying the new home page. The identification of a new homepage and changing of the homepage setting may be linked or asynchronous. For example, an embodiment may immediately update the homepage setting following the identification of a new homepage or an embodiment may wait to update a homepage setting until a user opens the web browser.

Additionally, more than one homepage setting may be provided by an embodiment. For example, an embodiment may provide two or more homepage settings, e.g., one for morning and one for evening. Thus, an embodiment may switch the homepage setting based on timing information alone (i.e., without attempting to identify a new homepage prior to changing the homepage setting for a given change). Again, the identifying of the new homepage and the changing of the homepage setting (or settings) may be asynchronous. Moreover, in the case where more than one homepage setting is provided, the identification of a new homepage for each setting may be asynchronous or linked, as described herein.

An embodiment will thus change the homepage setting at 340 such that when a user opens or launches the web browser at 350, the new homepage is used. That is, the new homepage is retrieved by the web browser, loaded and displayed on a display screen. Thus, a user may have his or her homepage conveniently updated (dynamically) in an intelligent fashion.

An embodiment may further be sensitive to user feedback (either explicit or inferred) in making changes to the homepage setting. For example, an embodiment may provide a user with a setting for opting out of dynamic changing, e.g., for a user that does not wish to continue experiencing the dynamic changing. The opt out setting may offer sub-options such that the opt out may be appropriately tailored. For example, a user may opt out of dynamic changes to the homepage during a specific time period (e.g., no dynamic changing during working hours) such that dynamic changing of the homepage only occurs at times convenient for the user. Alternatively (or additionally) the opt out feature may be implemented as an opt in feature (e.g., implement dynamic changing of the homepage setting at specific times or for a specific period of time).

An embodiment may infer user preferences as well. For example, an embodiment may track a user's behavior relative to the dynamic changing and update settings automatically. For example, an embodiment may detect that a user frequently changes a dynamically selected new homepage to a different homepage, e.g., by navigating to another web page or closing the web browser within a predetermined time of the new home page being loaded. An embodiment may therefore adjust the dynamic homepage selection or change settings appropriately. For example, an embodiment may infer an action indicative of dissatisfaction with the dynamic changing (either explicit in the case of an opt out or inferred as described herein) and update the dynamic changing appropriately, e.g., disabling dynamic changing for a predetermined time, during predetermined times, selecting a new homepage, e.g., a last known acceptable homepage (again as determined either explicitly or inferred based on stored history information) or the like. Thus, an embodiment may perform one or more additional actions responsive to an indication of dissatisfaction received from the user.

An embodiment therefore provides dynamic changing for homepage(s) in a web browser. This allows a user to avoid the need to type in or click through to preferred web pages and instead intelligently loads as a homepage a web page more suitable for the particular user.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
accessing a memory storing information comprising web page information and timing information;
identifying, using the one or more processors, a new web page to use as a homepage based on the web page information and the timing information; and
changing, using the one or more processors, a home page setting in a web browser to the new web page according to the web page information and the timing information.

2. The method of claim 1, wherein the web page information comprises a stored history of visited web pages.

3. The method of claim 1, wherein the timing information comprises local time at the information handling device when a web page is accessed using the information handling device.

4. The method of claim 1, further comprising:
determining a local time at the information handling device.

5. The method of claim 4, wherein the changing comprises changing the homepage setting to the new web page based on the local time at the information handling device.

6. The method of claim 4, further comprising creating a time-based ranking of web pages derived from a history of web page visits stored as web page information and timing information, wherein the changing comprises changing the homepage setting to the new web page based on the time-based ranking and the local time at the information handling device.

7. The method of claim 4, wherein the local time at the information handling device is associated with a portion of a day, and further wherein the portion of the day is used as representative of the local time.

8. The method of claim 1, further comprising:
responsive to an action opening the web browser for display on a display device, loading the new web page indicated in the home page setting;
receiving user input indicative of dissatisfaction of the new homepage; and
performing at least one additional action responsive to thereto.

9. The method of claim 8, wherein the user input indicative of dissatisfaction of the new homepage comprises an input selected from the group of inputs consisting of: closing the web browser; and navigating away from the new homepage within a predetermined time of loading the new home page.

10. The method of claim 9, wherein the at least one additional action comprises an action selected from the group of actions consisting of: re-instating a previously used homepage as the new homepage, selecting a last known acceptable homepage, and prompting the user to indicate a desired homepage.

11. An information handling device, comprising:
a display device;
one or more processors;
a memory device accessible to the one or more processors and storing code executable by the one or more processors to:
access a memory storing information comprising web page information and timing information;
identify a new web page to use as a homepage based on the web page information and the timing information; and
change a home page setting in a web browser that displays a home page on the display device to the new web page according to the web page information and the timing information.

12. The information handling device of claim 11, wherein the web page information comprises a stored history of visited web pages.

13. The information handling device of claim 11, wherein the timing information comprises local time at the information handling device when a web page is accessed using the information handling device.

14. The information handling device of claim 11, wherein the code is further executable by the one or more processors to:
determine a local time at the information handling device.

15. The information handling device of claim 14, wherein the changing comprises changing the homepage setting to the new web page based on the local time at the information handling device.

16. The information handling device of claim 14, wherein the code is further executable by the one or more processors to create a time based-ranking of web pages derived from a history of web page visits stored as web page information and timing information, wherein the changing comprises changing the homepage setting to the new web page based on the time-based ranking and the local time at the information handling device.

17. The information handling device of claim 14, wherein the local time at the information handling device is associated with a portion of a day, and further wherein the portion of the day is used as representative of the local time.

18. The information handling device of claim 11, wherein the code is further executable by the one or more processors to:
responsive to an action opening the web browser for display on the display device, load the new web page indicated in the home page setting;
receive user input indicative of dissatisfaction of the new homepage; and
perform at least one additional action responsive to thereto.

19. The information handling device of claim 18, wherein the user input indicative of dissatisfaction of the new homepage comprises an input selected from the group of inputs consisting of: closing the web browser; and navigating away from the new homepage within a predetermined time of loading the new home page.

20. A program product, comprising:
a storage device having computer readable program code stored therewith, the computer readable program code comprising:
computer readable program code configured to access a memory storing information comprising web page information and timing information;
computer readable program code configured to identify a new web page to use as a homepage based on the web page information and the timing information; and
computer readable program code configured to change a home page setting in a web browser to the new web page according to the web page information and the timing information.
